(19) United States
(12) Patent Application Publication
(10) Pub. No.: US 2007/0285497 A1
(43) Pub. Date: Dec. 13, 2007

(54) APPARATUS AND METHOD FOR ACTIVATING VIDEO FUNCTION

(75) Inventor: Ko-Chien Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: COMPAL ELECTRONICS, INC., Taipei (TW)

(21) Appl. No.: 11/686,363

(22) Filed: Mar. 15, 2007

(30) Foreign Application Priority Data
Apr. 24, 2006 (TW) 95114508

(51) Int. Cl. H04N 7/14

(52) U.S. Cl. 348/14.01; 348/E07.078

(57) ABSTRACT

An apparatus and a method for activating a video function are disclosed. The apparatus detects a great number of communication interfaces by using a monitor module and compares their priorities pre-defined by a user. When one of the communication interfaces is opened or closed, only the one with the highest priority is allowed to use the video function. Therefore, the interferences caused by simultaneously opening the communication interfaces can be avoided, and the video unit is not required to be re-activated, so as to achieve the purpose of providing the user with an easy operation.

### CROSS-REFERENCE TO RELATED APPLICATION

This application claims the priority benefit of Taiwan application serial no.95114508, filed Apr. 24, 2006. All disclosure of the Taiwan application is incorporated herein by reference.

### BACKGROUND OF THE INVENTION

1. Field of the Invention

The present invention relates to an apparatus and a method for activating a video function, and more particularly to an apparatus and a method which are capable of activating a video function and allocating video frames based on priorities.

2. Description of Related Art

With prevalence of internet at present, more and more users prefer communicating with others through real-time communication interfaces, such as MSN messenger, Yahoo messenger, ICQ, and so forth. The most common real-time communication interfaces in the current market are not only able to send/receive text messages, but also able to capture images from the users through recently-developed video units and instantly transfer the images to other users via internet. Thereby, the distance among the users is shortened.

However, due to the limitations on software and hardware, the video unit merely provides one real-time communication interface at a time for using the video function. As the user opens one communication interface and subsequently opens another, the communication interfaces may interfere with each other.

Moreover, as the user closes the real-time communication interface which is currently using the video function, the video unit is then closed simultaneously. If the user intends to resume video conversations through other real-time communication interfaces, the video unit therein should be re-activated, leading to an uneasy operation.

### SUMMARY OF THE INVENTION

In view of the foregoing, the present invention provides an apparatus for activating a video function to detect a plurality of communication interfaces and allow the communication interface with the highest priority to use the video function through a monitor module, such that the interferences caused by simultaneously opening a plurality of communication interfaces in the related art can be avoided.

The present invention further provides a method for activating a video function to detect if any other communication interface is opened when one of the communication interfaces is opened or closed. Additionally, the communication interface having the highest priority is provided with the authority to use the video function, such that different communication interfaces are provided -with the authority to use the video function in proper order -without re-activating the video unit.

The present invention provides an apparatus for activating a video function. Said apparatus includes a plurality of communication interfaces, a video unit, and a monitor module. The communication interfaces are used to communicate with a plurality of external users, and each communication interface is pre-defined with a priority. The video unit is employed to provide the video function. In addition, the monitor module is coupled to the communication interfaces and the video unit. When one of the communication interfaces is opened or closed, the monitor module detects if any other communication interface having a higher priority is opened. Then, the communication interface having the highest priority is allowed to use the video function provided by the video unit.

According to one embodiment of the present invention, the apparatus for activating the video function further includes a receiving interface which is coupled to the communication interfaces. The receiving interface receives image signals from a plurality of external users and provides these signals to the communication interfaces.

According to one embodiment of the present invention, the apparatus for activating the video function further includes a display unit which is coupled to the communication interfaces and used to display the image signal received by each communication interface.

According to one embodiment of the present invention, the apparatus for activating the video function further includes a driving module coupled to the video unit and the monitor module. The driving module drives the video unit so as to provide the video function. The aforesaid driving module can be a filter driver.

According to one embodiment of the present invention, the monitor module includes a detecting unit and a switching unit. The detecting unit detects if any other communication interface is opened, while the switching unit compares the priorities of the communication interfaces detected by the detecting unit, so as to allow the communication interface having the highest priority to use the video function provided by the video unit.

According to one embodiment of the present invention, only one of the communication interfaces is provided with the authority to use the video function at one time.

From another aspect, the present invention further provides a method for activating a video function. The method allocates a plurality of communication interfaces to use the video function. Here, each communication interface is pre-defined with a priority. Said method includes the following steps: first, one of the communication interfaces is opened. Next, whether any other communication interface is opened is determined. If any other communication interface is opened, the priorities of the opened communication interfaces are compared and the communication interface having the highest priority is provided with the authority to use the video function. On the contrary, if no other communication interface is opened, the currently-opened communication interface is provided with the authority to use the video function.

According to one embodiment of the present invention, the method for the communication interface to use the video function includes receiving an image signal transmitted from a video unit at first. Next, the image signal is transmitted to a display apparatus for display.

According to one embodiment of the present invention, the opened communication interface is temporarily suspended from using the video function when the opened communication interface has a lower priority than the communication interface to be opened.

From still another aspect, the present invention further provides a method for activating a video function. The method allocates a plurality of communication interfaces to use the video function. Here, each communication interface is pre-defined with a priority. Said method includes the following steps: first, one of the communication interfaces is closed. Next, whether any other communication interface is opened is determined. If no other communication interface is opened, the video function is closed. In contrast, if any other communication interface is opened, the communication interface having the highest priority is provided with the authority to use the video function.

In the apparatus and the method for activating the video function disclosed in the present invention, the authority to use the video function is determined upon the priority of each real-time communication interface detected by the monitor module. Thus, the interferences caused by simultaneously opening a plurality of the communication interfaces can be avoided. Further, the video unit is not required to be re-activated, so as to achieve the purpose of providing the user with an easy operation.

In order to make the aforementioned and other objects, features and advantages of the present invention more comprehensible, some embodiments accompanied with figures are described in detail below.

### BRIEF DESCRIPTION OF THE DRAWINGS

FIG. 1 is a block diagram of an apparatus for activating a video function according to an embodiment of the present invention.

FIG. 2 is a flow chart illustrating a method for activating a video function according to an embodiment of the present invention.

FIG. 3 is a flow chart illustrating a method for activating a video function according to another embodiment of the present invention.

### DESCRIPTION OF EMBODIMENTS

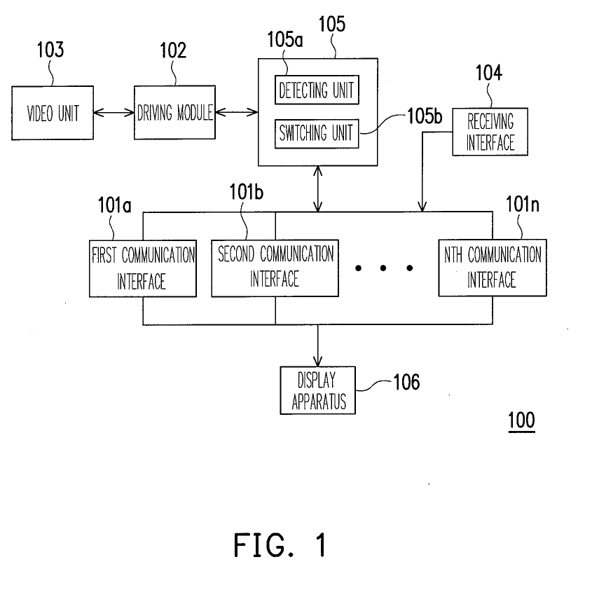

FIG. 1 is a block diagram of an apparatus for activating a video function according to an embodiment of the present invention. Referring to FIG. 1, in the present embodiment, the apparatus 100 for activating the video function includes a plurality of communication interfaces 101a˜101n, a driving module 102, a video unit 103, a receiving interface 104, a monitor module 105, and a display apparatus 106. Here, the communication interfaces 101a˜101n are connected to the video unit 103 through the monitor module 105 and the driving module 102, and also connected to the receiving interface 104 and the display apparatus 106 respectively.

The communication interfaces 101a˜101n include the communication interfaces provided by real-time communication software such as MSN messenger, ICQ, Yahoo messenger, and so on. Said software allocates the users to communicate with a plurality of external users. Each of the communication interfaces 101a˜101n is pre-defined with a priority. On the other hand, the video unit 103 is, for example, a charge coupled device (CCD) camera or a complementary metal-oxide semiconductor (CMOS) camera which enables the video function.

The monitor module 105 is used to detect if the communication interfaces 101a˜101n are opened and compare the priorities of the opened communication interfaces 101a˜101n, such that the opened communication interface having the highest priority is allowed to use the video function provided by the video unit 103. That is to say, only one of the communication interfaces 101a˜101n is provided with the authority to use the video function at one time.

Said monitor module 105 includes a detecting unit 105a and a switching unit 105b. The detecting unit 105a is utilized to detect if any of the communication interfaces 102a˜101n is opened, while the switching unit 105b is used to successively compare the priorities of the communication interfaces 101a˜101n detected by the detecting unit 105a, so as to allow the communication interface having the highest priority among all of the opened communication interfaces 101a˜101n to use the video function provided by the video unit 103.

Moreover, the driving module 102 is used to drive the video unit 103 so as to provide the video function, which may be performed by a filter driver or by hardware, but not limited to them. The receiving interface 104 is used to receive image signals from the external users and provide the image signals for the communication interfaces 101a˜101n. It should be noted that the image received by the receiving interface 104 is from the external users, while the image captured by the video unit 103 is from the users themselves. However, the communication interfaces 101a˜101n display every received image signal no matter if the image is provided by the external users or by the users themselves.

To further elaborate said embodiment, one more example is given hereinafter. When the detecting unit 105a detects that the communication interfaces 101a (e.g. MSN messenger), 101b (e.g. Yahoo messenger), and 101c (e.g. ICQ) are opened, the switching unit 105b starts comparing the priorities of the communication interfaces 101a, 101b and 101c pre-defined by the users. If the priority of the communication interface 101a is higher than those of the communication interfaces 101b and 101c, the communication interface 101a is provided with the authority to use the video function. Besides, in the meantime of using the video function, the communication interface 101a also receives the image signal from the external users through the receiving interface 104. Thereby, the display apparatus 106 is capable of displaying both the image from the external users and that from the users themselves.

Furthermore, as the communication interface 101a is closed by the users, the detecting unit 105a then detects if any other communication interface is opened. It is understood from the above that the communication interfaces 101b and 101c are still opened. Accordingly, the switching unit 105b compares the priorities of the communication interfaces 101b and 101c. If the communication interface 101b has a higher priority than the communication interface 101c, the communication interface 101b is allowed to use the video function provided by the video unit 103. Likewise, in the mean time of using the video function, the communication interface 101b receives the image signal from the external users through the receiving interface 104. Then, the display apparatus 106 displays the received image.

Noticeably, if another communication interface 101d is opened during the time the communication interface 101b is using the video function, the detecting unit 105a compares the priorities of the two communication interfaces 101b and 101d. If the communication interface 101d has a higher priority than the communication interface 101c but has a lower priority than the communication interface 101b, the communication interface 101d is temporarily suspended from using the video function until the communication interface 101b is closed.

It is concluded that no matter how many communication interfaces are opened or closed, the monitor module 105 merely allows the communication interface having the highest priority among all of the opened communication interfaces to use the video function provided by the video unit 103.

Moreover, as the user closes the communication interface which is using the video function (i.e. the communication interface having the highest priority), the monitor module 105 still allows the communication interface having the highest priority among all of the rest opened communication interfaces to use the video function. Thereby, as the communication interface is closed by the user, the burden of reactivating the video unit 103 disclosed in the related art is alleviated, so as to facilitate various operations.

More noticeably, the present invention is not limited to activate the video function through a plurality of communication interfaces. In the circumstance that a plurality of windows is opened with use of the same communication interface, the user is still able to record the priority of each contact in an address book built in the communication interface, such that the usage of the video function can be determined upon the priority of each contact. Likewise, this embodiment also achieves similar performance to that of the present invention.

For the same purpose, another two methods for activating the video function are illustrated below. The methods include the processes of activating the video function as one communication interface is opened or closed.

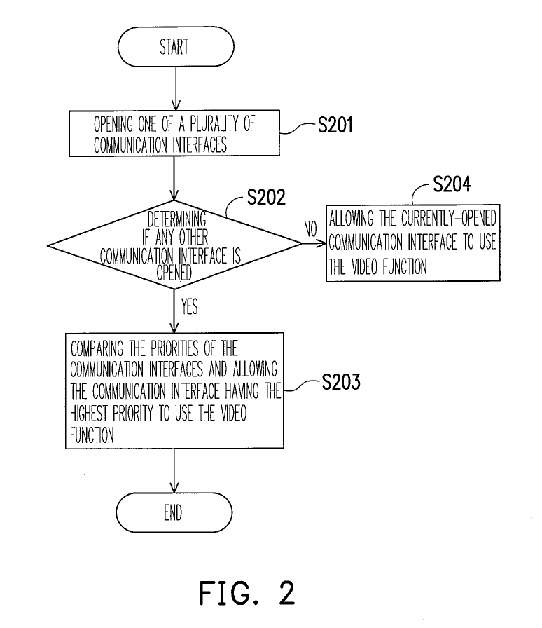

FIG. 2 is a flow chart illustrating a method for activating a video function according to another embodiment of the present invention. Referring to FIG. 2, the method for activating the video function enables a plurality of communication interfaces to use the video function when only one communication interface is opened at a time. Here, the priority of each of the communication interfaces is pre-defined. Said method includes the following steps:

First, in step S201, one of the communication interfaces is opened. For example, the user opens the communication interfaces such as ICQ, MSN messenger, Yahoo messenger, and so on. The type of the opened communication interface is not limited in the present invention.

Next, in step S202, whether any other communication interface is opened is determined. For example, if the user opens MSN messenger in step S201, it is necessary to detect if any other communication interface (e.g. ICQ or Yahoo messenger) is opened in step S202.

If any communication interface is opened in step S202, the priorities of the opened communication interfaces are compared and the communication interface having the highest priority is provided with the authority to use the video function in step S203. For example, if ICQ, MSN messenger, and Yahoo messenger are opened simultaneously, the priorities thereof are compared and the communication interface having the highest priority is provided with the authority to use the video function. On the contrary, if no other communication interface is opened, the currently-opened communication interface is provided with the authority to use the video function in step S204. In other words, if the communication interfaces such as ICQ and Yahoo messenger are not opened, MSN messenger is allowed to use the video function.

In addition, when the communication interface uses the video function, it also receives the image signal transmitted from another video unit at the same time. Thereafter, the image signal is transmitted to the display apparatus so as to display the received image signal.

It should be noted that the opened communication interface is temporarily suspended from using the video function when the opened communication interface has a lower priority than the communication interface to be opened. For example, if the user has opened MSN messenger and intends to open Yahoo messenger while the MSN messenger has a lower priority than the Yahoo messenger, the MSN messenger is temporarily suspended from using the video function while the Yahoo messenger is allowed. Until the Yahoo messenger is closed, the MSN messenger is again provided with the authority to use the video function.

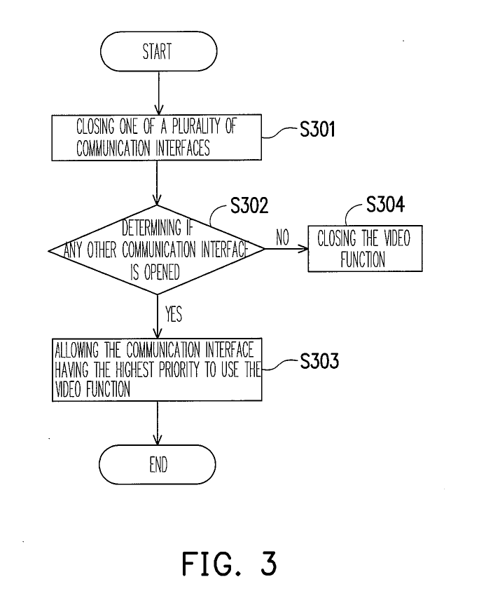

FIG. 3 is a flow chart illustrating a method for activating a video function according to another embodiment of the present invention. Referring to FIG. 3, the method for activating the video function allocates a plurality of communication interfaces to use the video function when only one communication interface is closed at a time. Each of the communication interfaces is pre-defined with a priority. Said method includes the following steps:

First, in step S301, one of the communication interfaces is closed. For example, one of the MSN messenger, ICQ, and Yahoo messenger is closed by the user.

Next, in step S302, whether any communication interface is opened is determined. If no communication interface is opened, the video function is closed in step S303. In contrast, if any communication interface is still opened, the communication interface having the highest priority is provided with the authority to use the video function in step S304.

To sum up, the present invention provides the apparatus and the method for activating the video function. According to said embodiments, the present invention has at least the following advantages:

1. The priorities of various communication interfaces are respectively defined, which avoids the interferences caused by simultaneously opening a plurality of communication interfaces.

2. Different communication interfaces are allowed to use the video function in proper order without re-activating the video unit.

3. The method of the present invention may be performed by using a filter driver, and thus no additional hardware is required.

Although the present invention has been disclosed above by the preferred embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. An apparatus for activating a video function, comprising:
a plurality of communication interfaces adapted to communicate with a plurality of external users respectively, wherein each communication interface is pre-defined with a priority;
a video unit adapted to provide a video function; and
a monitor module coupled to the communication interfaces and the video unit, wherein during the time one of the communication interfaces is opened or closed, the monitor module is adapted to detect if any other communication interface having a higher priority is opened, and the communication interface having the highest priority is allowed to use the video function provided by the video unit.

2. The apparatus of claim 1, further comprising:
a receiving interface coupled to the communication interfaces, wherein the receiving interface is adapted to receive an image signal from the external users and provide the image signal to the communication interfaces.

3. The apparatus of claim 2, further comprising:
a display unit coupled to the communication interfaces and adapted to display the image signal received by the communication interfaces.

4. The apparatus of claim 1, further comprising:
a driving module coupled to the video unit and the monitor module, wherein the driving module is adapted to drive the video unit so as to provide the video function.

5. The apparatus of claim 4, wherein the driving module comprises a filter driver.

6. The apparatus of claim 1, wherein the monitor module comprises:
a detecting unit adapted to detect if any other communication interface is opened; and
a switching unit adapted to compare the priorities of the communication interfaces detected by the detecting unit, so as to allow the communication interface having the highest priority to use the video function.

7. The apparatus of claim 1, wherein only one of the communication interfaces is provided with the authority to use the video function at one time.

8. A method for activating a video function, used for allocating a plurality of communication interfaces to use the video function, wherein each communication interface is pre-defined with a priority, the method comprising:
a. opening one of the communication interfaces; and
b. determining if any other communication interface is opened;
b1. comparing the priorities of the communication interfaces if any other communication interface is opened and allowing the communication interface having the highest priority to use the video function;
b2. allowing the currently-opened communication interface to use the video function if no other communication interface is opened.

9. The method of claim 8, wherein the method for the communication interface to use the video function comprises:
receiving an image signal transmitted from a video unit; and
transmitting the image signal to a display apparatus and displaying the image signal.

10. The method of claim 8, wherein in step 11, the opened communication interface is temporarily not allowed to use the video function when the opened communication interface has a lower priority than the communication interface to be opened.

11. A method for activating a video function, used for allocating a plurality of communication interfaces to use the video function, wherein each communication interface is pre-defined with a priority, the method comprising:
closing one of the communication interfaces;
determining if any communication interface is opened;
closing the video function if no other communication interface is opened; and
allowing the communication interface having the highest priority to use the video function if any communication interface is opened.
